(19) United States
(12) Patent Application Publication
(10) Pub. No.: US 2025/0332926 A1
(43) Pub. Date: Oct. 30, 2025

(54) Intelligent Eco Mode Optimization for Battery Electric Vehicles

(71) Applicant: Nissan North America, Inc., Franklin, TN (US)

(72) Inventors: Corey Heath, Scottsdale, AZ (US); Stefan Witwicki, San Carlos, CA (US); Atsushi Kasuya, Los Altos Hills, CA (US); Niloofar Zarei, Campbell, CA (US); Erik Lee St. Gray, Tacoma, WA (US); Marcell Jose Vazquez-Chanlatte, Palo Alto, CA (US); Yoshinori Sato, Aoba-ku (JP); Jeff Li Wen, Cupertino, CA (US); Kyle Holins Wray, Fremont, CA (US)

(21) Appl. No.: 18/651,430

(22) Filed: Apr. 30, 2024

(51) Int. Cl. B60L 15/20; B60L 58/12

(52) U.S. Cl. CPC B60L 15/2045; B60L 58/12; B60L 2240/14; B60L 2240/66; B60L 2240/68; B60L 2240/70; B60L 2260/26; B60L 2260/52; B60L 2260/54

(57) ABSTRACT

Intelligent eco mode optimization in a battery electric vehicle (BEV) includes collecting data from one or more systems of a vehicle in which the vehicle includes a battery. A predicted route is generated based on the collected data. The collected data includes a navigation map for a portion of a vehicle transportation network. A state of the vehicle is determined based on the collected data and the predicted route. A drive mode is determined, using a decision-making model, for the vehicle based on the state of the vehicle and the predicted route. The drive mode is either a first drive mode having a first acceleration curve or a second drive mode have a second acceleration curve and the second drive mode reduces a rate of discharge of the battery as compared to the first drive mode. The vehicle is set to use the drive mode.

### TECHNICAL FIELD

This disclosure relates generally to battery electric vehicles, and more particularly to eco mode activation planning for battery charging.

### BACKGROUND

A battery electric vehicle (BEV) typically includes an electric motor (powered by an electric battery) to move the vehicle. Additionally, energy recaptured via regenerative braking can be used to recharge the battery. A consideration in operation of BEVs is the ability to switch to one or more modes that optimize battery efficiency. Sub-optimal use may result in, for example, wasted energy and/or reduction in the life of the battery.

### SUMMARY

A first aspect of the disclosed implementations is a method for intelligent eco mode optimization in a battery electric vehicle (BEV). The method includes collecting data from one or more systems of a vehicle, wherein the vehicle comprises a battery, generating a predicted route based on the collected data, wherein the collected data includes a navigation map for a portion of a vehicle transportation network, determining a state of the vehicle based on the collected data and the predicted route, determining, using a decision-making model, a drive mode for the vehicle based on the state of the vehicle and the predicted route, wherein the drive mode one of a first drive mode having a first acceleration curve responsive to an operator request for acceleration or a second drive mode have a second acceleration curve responsive to the operator request for acceleration, wherein the second drive mode reduces a rate of discharge of the battery as compared to the first drive mode, and setting the vehicle to use the drive mode.

A second aspect of the disclosed implementations is an apparatus for intelligent eco mode optimization in a BEV. The apparatus includes a memory subsystem and one or more processors. The one or more processors is configured to execute instructions stored in the memory subsystem to collect data from one or more systems of a vehicle, wherein the vehicle comprises a battery, generate a predicted route based on the collected data, wherein the collected data includes a navigation map for a portion of a vehicle transportation network; determine a state of the vehicle based on the collected data and the predicted route, determine, using a decision-making model, a drive mode for the vehicle based on the state of the vehicle and the predicted route, wherein the drive mode one of a first drive mode having a first acceleration curve responsive to an operator request for acceleration or a second drive mode have a second acceleration curve responsive to the operator request for acceleration, wherein the second drive mode reduces a rate of discharge of the battery as compared to the first drive mode, and set the vehicle to use the drive mode.

A third aspect of the disclosed implementations is non-transitory computer-readable storage medium that include executable instructions that, when executed by one or more processors, facilitate (i.e., cause) performance of operations. The operations include collecting data from one or more systems of a vehicle, wherein the vehicle comprises a battery, generating a predicted route based on the collected data, wherein the collected data includes a navigation map for a portion of a vehicle transportation network, determining a state of the vehicle based on the collected data and the predicted route, determining, using a decision-making model, a drive mode for the vehicle based on the state of the vehicle and the predicted route, wherein the drive mode one of a first drive mode having a first acceleration curve responsive to an operator request for acceleration or a second drive mode have a second acceleration curve responsive to the operator request for acceleration, wherein the second drive mode reduces a rate of discharge of the battery as compared to the first drive mode, and setting the vehicle to use the drive mode.

Variations in these and other aspects, features, elements, implementations, and embodiments of the methods, apparatus, procedures, and algorithms disclosed herein are described in further detail hereafter.

### BRIEF DESCRIPTION OF THE DRAWINGS

The various aspects of the methods and apparatuses disclosed herein will become more apparent by referring to the examples provided in the following description and drawings in which like reference numbers refer to like elements.

FIG. 1 is a diagram of an example of a vehicle in which the aspects, features, and elements disclosed herein may be implemented.

FIG. 2 is a diagram of an example of a portion of a vehicle transportation and communication system in which the aspects, features, and elements disclosed herein may be implemented.

FIG. 3 illustrates an example of a configuration of battery electric vehicle systems in which the aspects, features, and elements disclosed herein may be implemented.

FIG. 4 illustrates a high-level flow of eco mode activation planning according to implementations of this disclosure.

FIG. 5 illustrates an example of a navigation map according to implementations of this disclosure.

FIGS. 6A-6C illustrate an example of operations of an eco mode activation planner according to implementations of this disclosure.

FIGS. 7A and 7B illustrate examples of an eco mode activation plan according to implementations of this disclosure.

FIG. 8 a flowchart diagram of an example of a technique for eco mode activation in accordance with an embodiment of this disclosure.

FIG. 9 is a flowchart diagram of an example of a technique for calculating the drive mode of a vehicle in accordance with an embodiment of this disclosure.

FIG. 10 is a flowchart diagram of an example of a technique for storing a trip record according to an implementation of this disclosure.

FIG. 11 visually illustrates an example of a state space according to implementations of this disclosure.

### DETAILED DESCRIPTION

As mentioned above, a battery electric vehicle (BEV) typically includes an electric battery. A consideration with battery electric engines is use of a mode where the rate of acceleration is limited when the accelerator pedal is pressed. Herein this is called eco mode.

Described herein are systems and techniques for intelligent eco mode activation using an eco mode activation planner (or, for brevity, planner). The planner determines (e.g., calculates, predicts, etc.) an eco mode activation policy for a vehicle (e.g., a BEV). Even when a route is not known (such as, for example, when a driver gets in the vehicle and starts driving), the planner can make decisions regarding eco mode activation actions (e.g., whether to turn the eco mode on or off). The planner can make the decisions using historical patterns of behaviors. The patterns of behaviors can be used to predict where the driver is likely to go (e.g., drive to, etc.) and make the eco mode activation decisions based on those predictions. As further described below, the policy can be optimized for many different types of objectives.

The patterns of behavior can be those of a single driver (e.g., the current driver of the vehicle), those of different drivers (e.g., multiple drivers of the same vehicle as each may have a different driving profile-one may drive very fast while another may be more conservative), those within a region (e.g., of all drivers/vehicles within the region), other patterns of behaviors, or a combination thereof.

In typical BEV systems, simple eco mode activation rules may be employed. For example, eco mode activation may be based on the state-of-charge (SoC) of the battery under different conditions. To illustrate, a policy may simply attempt to conserve battery life if a charge of the battery falls below a threshold percentage (e.g., 20%). For example, if the charge of the charge of the battery falls below 20%, then the eco mode can be turned on to conserve the remaining battery life. While simple, such eco mode activation approaches (referred to herein as hard-coded rules) are brittle and cannot benefit from predictions.

An eco mode activation planner according to implementations of this disclosure can anticipate road sections where a more responsive performance may be beneficial, thus temporarily deactivating eco mode for optimal energy use. For example, if the eco mode activation planner predicts an upcoming freeway on-ramp, merge zone, or significant incline along the vehicle's route, the system can proactively deactivate eco mode. This ensures that the driver has immediate access to the full acceleration capabilities of the BEV for these maneuvers. Additionally, the planner can leverage route data such as upcoming downhills. In anticipation of a downhill section where regenerative braking is possible, the eco mode activation planner might strategically keep eco mode deactivated on a preceding uphill section. This helps manage battery state-of-charge, ensuring ample capacity to capture the energy generated during regenerative braking on the downhill section.

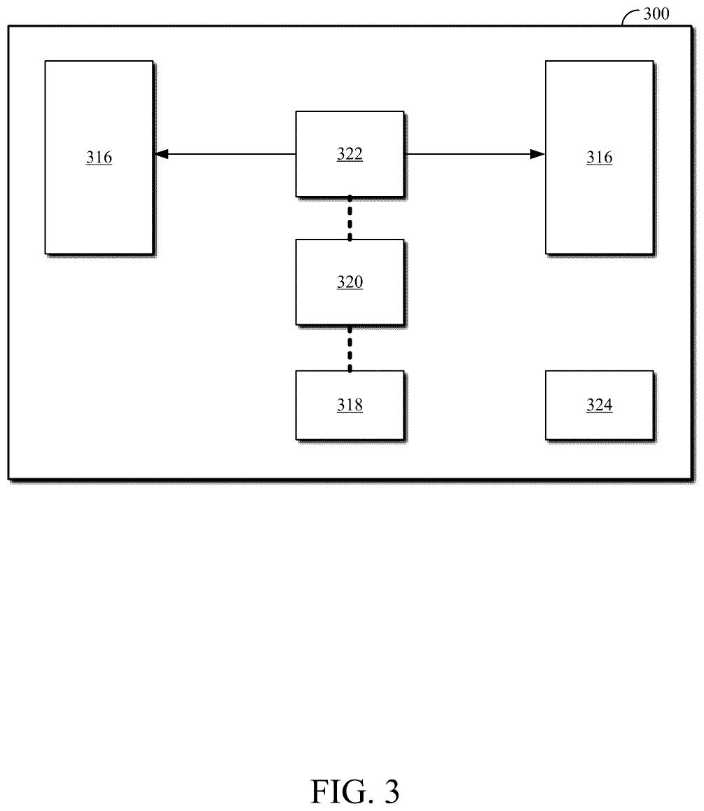

These and other optimizations can be realized by intelligent planning of eco mode activations for battery electric vehicles (BEVs) according to implementations of this disclosure. Examples of a configuration of BEVs are described with respect to FIG. 3. In an example, eco mode activation planning can be modeled as a type of Markov decision process (MDP) such as a multi-objective Markov decision process (MOMDP) problem. The MOMDP model can take a vehicle model and a navigation map as input and output an eco mode activation policy.

In an example, the vehicle model and/or the navigation map can be learned from Global Positioning System (GPS) traces with metadata, and can include topological road structures, traversal speeds/times, battery consumption/regeneration, and/or ambient noise. The metadata can be related to, or have a bearing on, the hybrid-related aspects of the vehicle (e.g., battery charging aspects and/or eco mode activation actions). For example, the metadata can include one or more of a battery charge (i.e., the SoC), slope, speed, acceleration, acceleration pedal status, brake pedal status, more, fewer, other metadata, or a combination thereof.

Different eco mode activation policies can be obtained for different objectives/goals therewith resulting in benefits related to the objectives/goals. A goal can be to minimize total energy consumption, such as based on anticipated hills, stops, and the like. Another goal can be to reduce the number of eco mode activations. Other goals or combinations of goals are also possible, allowing for customizable behavior relating to energy consumption, eco mode activations, travel time, and route planning, as further described below. For example, a route selected by a mapping service/application may be based on goals/objectives selected for the eco mode activation planner and/or related to eco mode activation.

Further details of an intelligent eco mode activation planner, route planning, and navigation map learning are described herein with initial reference to an environment in which it can be implemented.

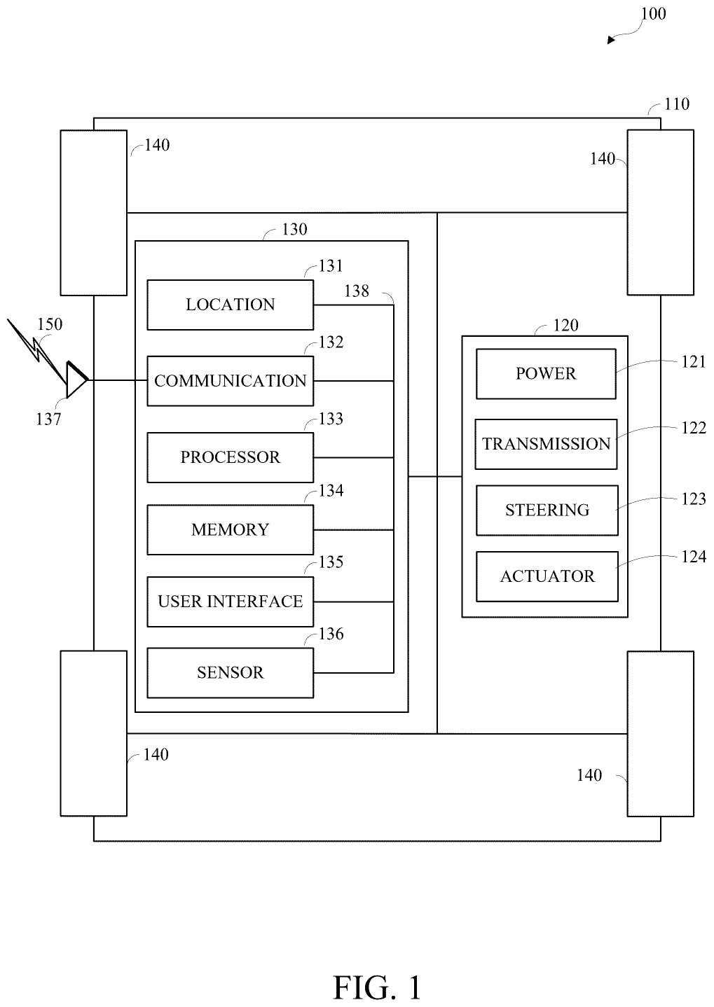

FIG. 1 is a diagram of an example of a vehicle in which the aspects, features, and elements disclosed herein may be implemented. In the embodiment shown, a vehicle 100 includes various vehicle systems. The vehicle systems include a chassis 110, a powertrain 120, a controller 130, and wheels 140. Additional or different combinations of vehicle systems may be used. Although the vehicle 100 is shown as including four wheels 140 for simplicity, any other propulsion device or devices, such as a propeller or tread, may be used. In FIG. 1, the lines interconnecting elements, such as the powertrain 120, the controller 130, and the wheels 140, indicate that information, such as data or control signals, power, such as electrical power or torque, or both information and power, may be communicated between the respective elements. For example, the controller 130 may receive power from the powertrain 120 and may communicate with the powertrain 120, the wheels 140, or both, to control the vehicle 100, which may include accelerating, decelerating, steering, or otherwise controlling the vehicle 100.

The powertrain 120 shown by example in FIG. 1 includes a power source 121, a transmission 122, a steering unit 123, and an actuator 124. Any other element or combination of elements of a powertrain, such as a suspension, a drive shaft, axles, or an exhaust system may also be included. Although shown separately, the wheels 140 may be included in the powertrain 120.

The power source 121 includes an engine, a battery, or a combination thereof. The power source 121 may be any device or combination of devices operative to provide energy, such as electrical energy, thermal energy, or kinetic energy. In an example, the power source 121 includes an engine, such as an internal combustion engine, an electric motor, or a combination of an internal combustion engine and an electric motor and is operative to provide kinetic energy as a motive force to one or more of the wheels 140. Alternatively, or additionally, the power source 121 includes a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 122 receives energy, such as kinetic energy, from the power source 121, transmits the energy to the wheels 140 to provide a motive force. The transmission 122 may be controlled by the controller 130, the actuator 124, or both. The steering unit 123 may be controlled by the controller 130, the actuator 124, or both and control the wheels 140 to steer the vehicle. The actuator 124 may receive signals from the controller 130 and actuate or control the power source 121, the transmission 122, the steering unit 123, or any combination thereof to operate the vehicle 100.

In the illustrated embodiment, the controller 130 includes a location unit 131, an electronic communication unit 132, a processor 133, a memory 134, a user interface 135, a sensor 136, and an electronic communication interface 137. Fewer of these elements may exist as part of the controller 130. Although shown as a single unit, any one or more elements of the controller 130 may be integrated into any number of separate physical units. For example, the user interface 135 and the processor 133 may be integrated in a first physical unit and the memory 134 may be integrated in a second physical unit. Although not shown in FIG. 1, the controller 130 may include a power source, such as a battery. Although shown as separate elements, the location unit 131, the electronic communication unit 132, the processor 133, the memory 134, the user interface 135, the sensor 136, the electronic communication interface 137, or any combination thereof may be integrated in one or more electronic units, circuits, or chips.

The processor 133 may include any device or combination of devices capable of manipulating or processing a signal or other information now-existing or hereafter developed, including optical processors, quantum processors, molecular processors, or a combination thereof. For example, the processor 133 may include one or more special purpose processors, one or more digital signal processors, one or more microprocessors, one or more controllers, one or more microcontrollers, one or more integrated circuits, one or more Application Specific Integrated Circuits, one or more Field Programmable Gate Array, one or more programmable logic arrays, one or more programmable logic controllers, one or more state machines, or any combination thereof. The processor 133 is operatively coupled with one or more of the location unit 131, the memory 134, the electronic communication interface 137, the electronic communication unit 132, the user interface 135, the sensor 136, and the powertrain 120. For example, the processor may be operatively coupled with the memory 134 via a communication bus 138.

The memory 134 includes any tangible non-transitory computer-usable or computer-readable medium, capable of, for example, containing, storing, communicating, or transporting machine readable instructions, or any information associated therewith, for use by or in connection with any processor, such as the processor 133. The memory 134 may be, for example, one or more solid state drives, one or more memory cards, one or more removable media, one or more read-only memories, one or more random access memories, one or more disks, including a hard disk, a floppy disk, an optical disk, a magnetic or optical card, or any type of non-transitory media suitable for storing electronic information, or any combination thereof. For example, a memory may be one or more read only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

The communication interface 137 may be a wireless antenna, as shown, a wired communication port, an optical communication port, or any other wired or wireless unit capable of interfacing with a wired or wireless electronic communication medium 150. Although FIG. 1 shows the communication interface 137 communicating via a single communication link, a communication interface may be configured to communicate via multiple communication links. Although FIG. 1 shows a single communication interface 137, a vehicle may include any number of communication interfaces.

The communication unit 132 is configured to transmit or receive signals via a wired or wireless electronic communication medium 150, such as via the communication interface 137. Although not explicitly shown in FIG. 1, the communication unit 132 may be configured to transmit, receive, or both via any wired or wireless communication medium, such as radio frequency (RF), ultraviolet (UV), visible light, fiber optic, wireline, or a combination thereof. Although FIG. 1 shows a single communication unit 132 and a single communication interface 137, any number of communication units and any number of communication interfaces may be used. In some embodiments, the communication unit 132 includes a dedicated short range communications (DSRC) unit, an on-board unit (OBU), or a combination thereof.

The location unit 131 may determine geolocation information, such as longitude, latitude, elevation, direction of travel, or speed, of the vehicle 100. In an example, the location unit 131 includes a GPS unit, such as a Wide Area Augmentation System (WAAS) enabled National Marine-Electronics Association (NMEA) unit, a radio triangulation unit, or a combination thereof. The location unit 131 can be used to obtain information that represents, for example, a current heading of the vehicle 100, a current position of the vehicle 100 in two or three dimensions, a current angular orientation of the vehicle 100, or a combination thereof.

The user interface 135 includes any unit capable of interfacing with a person, such as a virtual or physical keypad, a touchpad, a display, a touch display, a heads-up display, a virtual display, an augmented reality display, a haptic display, a feature tracking device, such as an eye-tracking device, a speaker, a microphone, a video camera, a sensor, a printer, or any combination thereof. The user interface 135 may be operatively coupled with the processor 133, as shown, or with any other element of the controller 130. Although shown as a single unit, the user interface 135 may include one or more physical units. For example, the user interface 135 may include both an audio interface for performing audio communication with a person and a touch display for performing visual and touch-based communication with the person. The user interface 135 may include multiple displays, such as multiple physically separate units, multiple defined portions within a single physical unit, or a combination thereof.

The sensors 136 are operable to provide information that may be used to control the vehicle. The sensors 136 may be an array of sensors. The sensors 136 may provide information regarding current operating characteristics of the vehicle 100, including vehicle operational information. The sensors 136 can include, for example, a speed sensor, acceleration sensors, a steering angle sensor, traction-related sensors, braking-related sensors, steering wheel position sensors, eye tracking sensors, seating position sensors, or any sensor, or combination of sensors, which are operable to report information regarding some aspect of the current dynamic situation of the vehicle 100.

The sensors 136 include one or more sensors 136 that are operable to obtain information regarding the physical environment surrounding the vehicle 100, such as operational environment information. For example, one or more sensors may detect road geometry, such as lane lines, and obstacles, such as fixed obstacles, vehicles, and pedestrians. The sensors 136 can be or include one or more video cameras, laser-sensing systems, infrared-sensing systems, acoustic-sensing systems, or any other suitable type of on-vehicle environmental sensing device, or combination of devices, now known or later developed. In some embodiments, the sensors 136 and the location unit 131 are combined.

Although not shown separately, the vehicle 100 may include a trajectory controller. For example, the controller 130 may include the trajectory controller. The trajectory controller may be operable to obtain information describing a current state of the vehicle 100 and a route planned for the vehicle 100, and, based on this information, to determine and optimize a trajectory for the vehicle 100. In some embodiments, the trajectory controller may output signals operable to control the vehicle 100 such that the vehicle 100 follows the trajectory that is determined by the trajectory controller. For example, the output of the trajectory controller can be an optimized trajectory that may be supplied to the powertrain 120, the wheels 140, or both. In some embodiments, the optimized trajectory can be control inputs such as a set of steering angles, with each steering angle corresponding to a point in time or a position. In some embodiments, the optimized trajectory can be one or more paths, lines, curves, or a combination thereof.

One or more of the wheels 140 may be a steered wheel that is pivoted to a steering angle under control of the steering unit 123, a propelled wheel that is torqued to propel the vehicle 100 under control of the transmission 122, or a steered and propelled wheel that may steer and propel the vehicle 100.

Although not shown in FIG. 1, a vehicle may include additional units or elements not shown in FIG. 1, such as an enclosure, a Bluetooth® module, a frequency modulated (FM) radio unit, a Near Field Communication (NFC) module, a liquid crystal display (LCD) display unit, an organic light-emitting diode (OLED) display unit, a speaker, or any combination thereof.

The vehicle 100 may be an autonomous vehicle that is controlled autonomously, without direct human intervention, to traverse a portion of a vehicle transportation network. Although not shown separately in FIG. 1, an autonomous vehicle may include an autonomous vehicle control unit that performs autonomous vehicle routing, navigation, and control. The autonomous vehicle control unit may be integrated with another unit of the vehicle. For example, the controller 130 may include the autonomous vehicle control unit.

When present, the autonomous vehicle control unit may control or operate the vehicle 100 to traverse a portion of the vehicle transportation network in accordance with current vehicle operation parameters. The autonomous vehicle control unit may control or operate the vehicle 100 to perform a defined operation or maneuver, such as parking the vehicle. The autonomous vehicle control unit may generate a route of travel from an origin, such as a current location of the vehicle 100, to a destination based on vehicle information, environment information, vehicle transportation network information representing the vehicle transportation network, or a combination thereof, and may control or operate the vehicle 100 to traverse the vehicle transportation network in accordance with the route. For example, the autonomous vehicle control unit may output the route of travel to the trajectory controller to operate the vehicle 100 to travel from the origin to the destination using the generated route.

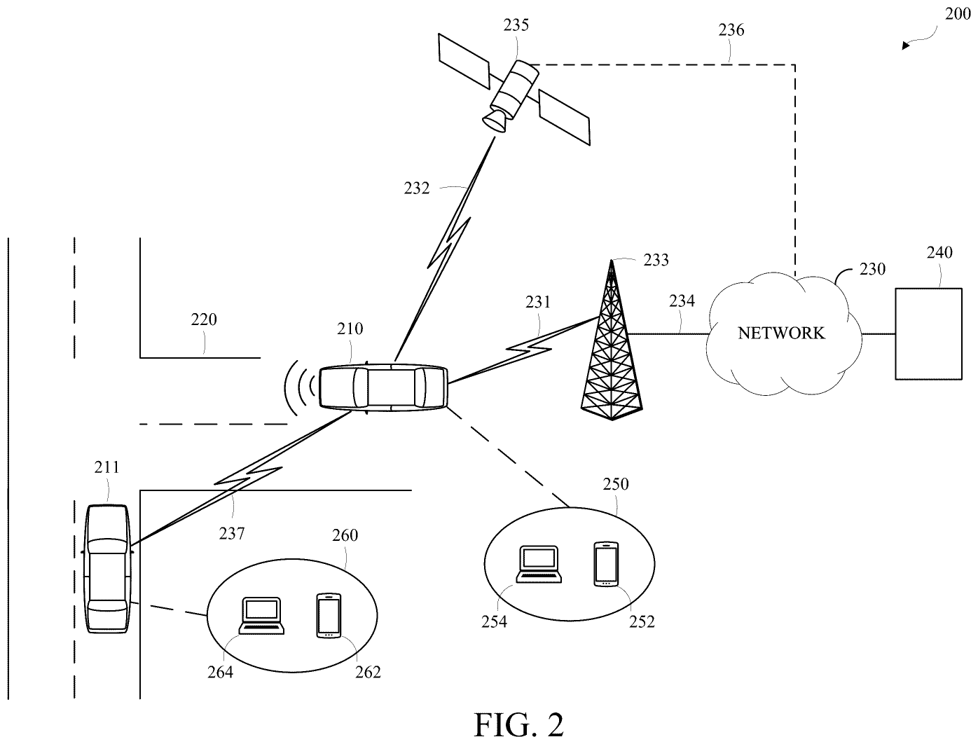

FIG. 2 is a diagram of an example of a portion of a vehicle transportation and communication system in which the aspects, features, and elements disclosed herein may be implemented. The vehicle transportation and communication system 200 may include one or more vehicles 210/211, such as the vehicle 100 shown in FIG. 1, which travels via one or more portions of the vehicle transportation network 220, and communicates via one or more electronic communication networks 230. Although not explicitly shown in FIG. 2, a vehicle may traverse an off-road area.

The electronic communication network 230 may be, for example, a multiple access system that provides for communication, such as voice communication, data communication, video communication, messaging communication, or a combination thereof, between the vehicle 210/211 and one or more communication devices 240. For example, a vehicle 210/211 may receive information, such as information representing the vehicle transportation network 220, from a communication device 240 via the electronic communication network 230.

In some embodiments, a vehicle 210/211 may communicate via a wired communication link (not shown), a wireless communication link 231/232/237, or a combination of any number of wired or wireless communication links. As shown, a vehicle 210/211 communicates via a terrestrial wireless communication link 231, via a non-terrestrial wireless communication link 232, or via a combination thereof. The terrestrial wireless communication link 231 may include an Ethernet link, a serial link, a Bluetooth link, an infrared (IR) link, an ultraviolet (UV) link, or any link capable of providing for electronic communication.

A vehicle 210/211 may communicate with another vehicle 210/211. For example, a host, or subject, vehicle (HEV) 210 may receive one or more automated inter-vehicle messages, such as a basic safety message (BSM), from a remote, or target, vehicle (RV) 211, via a direct communication link 237, or via an electronic communication network 230. The remote vehicle 211 may broadcast the message to host vehicles within a defined broadcast range, such as 300 meters. In some embodiments, the host vehicle 210 may receive a message via a third party, such as a signal repeater (not shown) or another remote vehicle (not shown). A vehicle 210/211 may transmit one or more automated inter-vehicle messages periodically, based on, for example, a defined interval, such as 100 milliseconds.

Automated inter-vehicle messages may include vehicle identification information, geospatial state information, such as longitude, latitude, or elevation information, geospatial location accuracy information, kinematic state information, such as vehicle acceleration information, yaw rate information, speed information, vehicle heading information, braking system status information, throttle information, steering wheel angle information, or vehicle routing information, or vehicle operating state information, such as vehicle size information, headlight state information, turn signal information, wiper status information, transmission information, or any other information, or combination of information, relevant to the transmitting vehicle state. For example, transmission state information may indicate whether the transmission of the transmitting vehicle is in a neutral state, a parked state, a forward state, or a reverse state.

The vehicle 210 may communicate with the electronic communication network 230 via an access point 233. The access point 233, which may include a computing device, is configured to communicate with a vehicle 210, with an electronic communication network 230, with one or more communication devices 240, or with a combination thereof via wired or wireless communication links 231/234. For example, the access point 233 may be a base station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit here, an access point may include any number of interconnected elements.

The vehicle 210 may communicate with the electronic communications network 230 via a satellite 235, or other non-terrestrial communication device. The satellite 235, which may include a computing device, is configured to communicate with a vehicle 210, with an electronic communication network 230, with one or more communication devices 240, or with a combination thereof via one or more communication links 232/236. Although shown as a single unit here, a satellite may include any number of interconnected elements.

An electronic communication network 230 is any type of network configured to provide for voice, data, or any other type of electronic communication. For example, the electronic communication network 230 may include a local area network (LAN), a wide area network (WAN), a virtual private network (VPN), a mobile or cellular telephone network, the Internet, or any other electronic communication system. The electronic communication network 230 uses a communication protocol, such as the transmission control protocol (TCP), the user datagram protocol (UDP), the internet protocol (IP), the real-time transport protocol (RTP) the HyperText Transport Protocol (HTTP), or a combination thereof. Although shown as a single unit here, an electronic communication network may include any number of interconnected elements.

The vehicle 210 may identify a portion or condition of the vehicle transportation network 220. For example, the vehicle includes at least one on-vehicle sensor 209, like the sensor 136 shown in FIG. 1, which may be or include a speed sensor, a wheel speed sensor, a camera, a gyroscope, an optical sensor, a laser sensor, a radar sensor, a sonic sensor, or any other sensor or device or combination thereof capable of determining or identifying a portion or condition of the vehicle transportation network 220.

The vehicle 210 may traverse a portion or portions of the vehicle transportation network 220 using information communicated via the electronic communication network 230, such as information representing the vehicle transportation network 220, information identified by one or more on-vehicle sensors 209, or a combination thereof.

Although FIG. 2 shows one vehicle transportation network 220, one electronic communication network 230, and one communication device 240, for simplicity, any number of networks or communication devices may be used. The vehicle transportation and communication system 200 may include devices, units, or elements not shown in FIG. 2. Although the vehicle 210 is shown as a single unit, a vehicle may include any number of interconnected elements.

Although the vehicle 210 is shown communicating with the communication device 240 via the electronic communication network 230, the vehicle 210 may communicate with the communication device 240 via any number of direct or indirect communication links. For example, the vehicle 210 may communicate with the communication device 240 via a direct communication link, such as a Bluetooth communication link.

FIG. 3 illustrates an example of a configuration 300 of a BEV system in which the aspects, features, and elements disclosed herein may be implemented. Implementations of eco mode activation planning according to implementations of this disclosure can be implemented in BEV systems including those described with respect to FIG. 3.

In the configuration 300, wheels 316 are driven by the electric motor 322. The electric motor 322 transforms electric energy stored in an electric battery 318 into mechanical energy to drive the wheels 316. The electric motor 322 obtains its power from the electric battery 318 via an inverter 320. The electric battery 318 stores electric energy and supplies the energy to the motor as needed. The inverter 320 converts direct-current (DC) stored in the electric battery 318 to alternating-current (AC) power and supplies the resultant AC power to the electric motor 322, which then drives the wheels 316. When the vehicle decelerates, energy can be captured and stored in the electric battery 318 via regenerative braking. The inverter 320 converts DC and AC to manage the electric power between the electric battery 318 and the electric motor 322. The electric battery 318 can be a lightweight, compact, high-performance battery, such as a lithium-ion battery.

A control module 324 controls the operation of the vehicle. For example, the control module 324 can determine when the vehicle utilizes eco mode. The control module 324 can be or can include a processor, such as the processor 133 of FIG. 1. The control module 324 can execute an eco mode activation planner according to implementations of this disclosure. The eco mode activation planner can be stored in a memory, such as the memory 134 of FIG. 1, as executable instructions that, when executed by the processor, determine an activation of dirre the eco mode of the vehicle. The activation action can be an action to turn on the eco mode or to turn off the eco mode. The control module 324 can be implemented using specialized hardware or firmware.

The control module 324 activates the eco mode according to the activation action. In an example, the control module 324 may directly communicate with (e.g., transmit signals or commands to, etc.) the electric motor 322 to activate (e.g., turn on or off) the eco mode according to the activation action. In an example, the control module 324 may transmit the activation action to an electric motor control module (not shown) that, in turns, activates the eco mode according to the activation action.

As mentioned above, eco mode activation planning can be determined based on a decision model, e.g., a multi-objective Markov decision process (MOMDP). An overview of an example of a formal model is now presented.

The decision model can be formally modeled as a tuple [symbol] S, A, T, C [symbol] . The variable S (i.e., S^{T}×S^{B}×S^{M}) can be a finite set of state (i.e., S^{T}—current road S^{B}—battery level, S^{M}—eco mode). The variable A can be a finite set of actions (i.e., eco mode on, eco mode off). The variable T (i.e., T(s, a, s″)) can be a state transition function that represents the probability that successor state s′∈S occurs after performing an action a∈A in a state s∈S. The variable C(s, a) can represent a cost function that represents the expected immediate cost(s) of performing an action a∈A in a state s∈S. Additionally, there can be multiple distinct cost functions (i.e., multi-dimensional cost vector). Each distinct cost function can be related to a difference object including but not limited to minimizing total energy (kWh), minimizing battery consumption, minimizing battery regeneration, minimizing wasted energy, minimizing eco mode toggles, or minimizing travel time.

A solution to the model can be a policy π:S→A. That is, under the policy π, an action a (i.e., π(s)) is selected for a state s. That is, the policy It can indicate that the action π(s)∈A should be taken in state s. The policy π can include a value function V^{π}: S→C that can represent the expected cumulative cost V^{π}(s) of reaching a goal state, from a state s following the policy π. That is, the value function can provide an expected cost (i.e., a value) for each intermediate state, from the start state until a goal state is reached. An optimal policy π* minimizes the expected cumulative cost.

To achieve a balance between eco mode activations, the decision model may employ multiple scalarization functions, e.g., within an MOMDP. Different scalarization functions translate the multi-dimensional cost vector into a single cost value, thereby accommodating varying optimization priorities. For example, a linear weighted sum function could prioritize a balance between energy efficiency and travel time, while a Chebyshev scalarization function might focus on minimizing deviations from ideal targets across all objectives. By using a range of scalarization functions, the system can generate a set of Pareto-optimal policies, each exhibiting a distinct behavior (e.g., minimize energy use, maximize performance, optimize energy and performance, etc.) tailored to the user's preferences or changing environmental conditions. The scalarization function can be used to convert the model/problem into a shortest path optimization problem (SSP). That is, a single value indicating the long-term utility of a next immediate action can be obtained using the scalarization function, which combines the expected costs to obtain the single value.

For example, an assumption may be made that at least two objectives are possible: a first objective to minimize battery consumption and a second objective to minimize wasted energy. Wasted energy can result, for example, when the battery is at a certain capacity (e.g., 100%) and can't be charged further by available energy from regenerative braking. Thus, the available energy is wasted energy. Depending on which of the objectives is selected (such as by default or by the driver) as the more important or primary goal, different weights can be assigned to each of the first and second costs associated with the objectives. In an example, the scalarization function can be a weighting the total energy plus a very small constant factor for battery consumption and wasted energy and for toggling of the eco mode. Examples of objectives and costs are further described below.

In another example, constrained optimization can be used where a respective budget (e.g., a range, a maximum, a minimum) can be set for each of the costs and where the costs can be ranked in terms of importance. For example, a single objective (e.g., minimize battery consumption or minimize travel time) can be set as a primary objective to be optimized. A model (such as an MOMDP) can consider each objective in a particular order. The model can constrain the available actions and/or policies for subsequent objectives following the particular order. For example, for a first objective, a set of actions A(s) can be kept (e.g., maintained, etc.) for each state s. Only the actions that satisfy a value criteria can be kept in the action set A(s) for each state. The second objective in the ordering can then solve its objective while being constrained to the available actions/policies that the first objective limited its access to. This process repeats until all objectives have been examined.

An eco mode activation planner according to this disclosure can plan an eco mode activation (i.e., an activation action) for each possible state that could arise. As a vehicle operates, the plan can be further refined. That is, given a current position of the vehicle, the eco mode activation planner can plan whether an eco mode of an electric motor, such as the electric motor 322 of FIG. 3, should be turned on or off. In an example, the eco mode activation planner can use driving patterns of a navigation map.

The navigation map can include learned historical driving patterns. The navigation map can include learned final goal (e.g., destination) locations. The historical driving patterns can be those of a particular vehicle for which an activation plan (e.g., policy) is to be calculated, those of a particular driver of the particular vehicle, and/or those of an aggregated learned historical driving pattern of several vehicles, several drivers, or both.

Before further describing the constituents of the tuple [symbol] S, A, T, C [symbol] of the model (e.g., an MOMDP), vehicle parameters and a navigation map used to build the model are first described.

The vehicle parameters can be or can include any relevant vehicle-specific information that can be used by the model for eco mode activation planning. The vehicle parameters may include but are not limited to the current charge of the battery and a drive mode (i.e., eco mode on, eco mode off).

In an example, the vehicle parameters may be known a priori. In another example, the vehicle parameters can be learned. In an example, respective constants can be learnt for at least some of the parameters by averaging each over time. Thus, values corresponding to at least some of the vehicle parameters can be collected from the vehicle over time and then averaged. In an example, respective functions can be fit to at least some of the vehicle parameters.

The navigation map can be defined as a directed graph [symbol] V, E [symbol] of vertices V and edges E. Each vertex v∈V can have the parameters latitude, longitude, and altitude, as shown in Table I. Each vertex v defines a coordinate in space as well as another parameter comprising a unique identifier (Id). The vertices can have fewer, more, other parameters, or a combination thereof.

TABLE I

| Parameter Name | Units | Parameter |
|---|---|---|
| Id | — | ν_{id} |
| Latitude | Degrees | νₗₐₜ |
| Longitude | Degrees | νₗₒₙ |
| Altitude | M | νₐₗₜ |

Each edge e∈E can have the parameters listed in Table II. An edge e connects two vertices. As such, an edge e can have the parameters From Vertex Id (which identifies a first node), To Vertex Id (which identifies a second node), a unique Id, and semantic road traversal information usable by the eco mode activation planner. In an example, the semantic road traversal information useful for eco mode activation planning can include one or more of the following parameters. A parameter eₙₜₜ denotes the number of times that the edge has been traversed. A parameter eₐₛ denotes the average speed of all the traversals of the edge. A parameter e_{abcr} denotes the average battery consumption/regeneration, which refers to all non-stop driving along the edge. The average battery consumption/regeneration e_{abcr} automatically incorporates the consequences of slope of the edge, road type of the edge, and traffic on the edge by simply recording, on average, how much change in battery level there was after traversal. A vertex also independently models full stops, denoting how many times a stop occurred eₙₜₛ, the duration of the stop eₐₛₜ, and how the average battery level changes from regenerative braking e_{abrs}. The parameter eₑₘₐ captures if the eco mode was active along the edge.

TABLE II

| Name | Units | Parameter |
|---|---|---|
| Id | — | e_{id} |
| From Vertex Id | — | e_{from} |
| To Vertex Id | — | eₜₒ |
| Number of Times Traversed | — | eₙₜₜ |
| Number of Times Stopped | — | eₙₜₛ |
| Average Speed | km/h | eₐₛ |
| Average Traversal Time | H | eₐₜₜ |
| Average Stop Time | H | eₐₛₜ |
| Average Battery Consumption/Regeneration | kWh | e_{abcr} |
| Average Battery Regeneration On Stop | kWh | e_{abrs} |
| Eco mode activated | — | eₑₘₐ |

In an example, the navigation map can be obtained, e.g., learned, acquired, purchased, leveraged, used, etc. The navigation map may be purchased from a third party (i.e., an external source) that maintains such information. The navigation map can be learned as a vehicle is traversing the roads. In an example, the navigation map may be an obtained navigation map that is updated by driving history of the vehicle. The navigation map may be available as a callable service (such as a cloud-based service), which the eco mode activation planner can programmatically call to request navigation map information that the planner requires.

In some implementations, some of the parameters of the navigation map may have different semantics than those described above. To illustrate, for example in the case of a purchased navigation map, the Number of Times Traversed may be given in the form of a probability. The probability can also be computed from, for example, the number of times traversed and a number of all outgoing edges.

In an example, the driving history can be captured, and the navigation history can be learned from GPS traces. A GPS trace can be defined as a vector \vec{g}= [symbol] g₁, . . . , g_{|\vec{g}|} [symbol] of GPS locations along a driving path of the vehicle. The set of all GPS traces is the set G. For each GPS trace, which is formed of discrete points, the discrete points \vec{g}ᵢ, \vec{g}ⱼ∈G are paired for each contiguous road segment length that is within a pre-defined tolerance dₜₒₗ>0 from one another. In an example, the pre-defined tolerance dₜₒₗ can be 100 meters. However, other lengths are possible. The average of the beginning points and the average of the end points in the segment of \vec{g}ᵢ and \vec{g}ⱼ form two vertices. An edge can then be added to the navigation map that contains the parameters of the navigation map, such as those described above with respect to Table III. That is, an edge that is added to the navigation map can average recorded speeds, battery consumption, etc. along the segments. Adding edges to the navigation map can also include adding vertices corresponding to the edge.

It is noted that Average Battery Consumption/Regeneration can be stochastic based at least on (1) the branching statistical distribution of edge traversal times (further described below) of a navigation map, (2) multiple possible routes splitting and joining to reach the same goal, and (3) regenerative braking during stochastic stops in slow traffic and traffic lights. Thus, the battery level at any upcoming navigation map edge can have an associated probability distribution. This stochastic process can be naturally modeled as a Markov chain; however, actions (such as turning on or off the eco mode) can affect the battery level. Thus, the MOMDP, which is a generalization of a MDP, can more accurately model the eco mode activation planning process and is preferred but not required.

In an example, the navigation map can include two parts. A first part can be fixed (e.g., purchased, static, unchangeable) and can include parameters such as Average Speed and the like. A second part can be a learned part and is necessary for determining an optimal eco mode activation plan. The second part of the navigation map can be unique to a particular vehicle (or a particular driver of the vehicle). Using this information, the planner can create the optimal plan without knowing the destination of the vehicle.

Where the destination of the vehicle is known (such as when a driver enters a destination in a routing application), then an optimal eco mode activation plan can be determined deterministically. Provided a known destination, the navigation map structure can be easily derived (such as from the routing application). The optimal eco mode activation plan can be easily derived because the planner knows what to expect (e.g., hills, residential areas, highway, traffic signs, etc.) along the way.

When the destination is not known, then the planner plans over the space of all (e.g., sampled) possible routes that the vehicle may take including all (e.g., sampled) possible destinations. To make the problem more tractable, information regarding which routes (e.g., a series of edges) the vehicle has taken, the Number of Times Traversed (and/or Probability of Taking), and the like can be accumulated in the second part of the navigation map.

The constituents of the tuple [symbol] S, A, T, C [symbol] of a model, particularly an MOMDP in this example, can now be further described.

The state space can be defined as S=S^{T}×S^{B}×S^{M}. In this equation, S^{M} is the current eco mode, which can be off or on such that S^{M}={off, on}. Further, S^{T}=E, the set of edges in the navigation map. As such, S^{T} can be the set of roads (or more accurately, road segments) in a navigation map, which is further described below. The set of roads S^{T} can be the set of roads that the vehicle has historically driven. Finally, S^{B}⊂[0, θ_{bc}] is the current battery level (in kWh), which can be in the range of 0 to the total battery capacity θ_{bc}kWh. The current battery level can be discretized at a regular interval/resolution. For example, given a discretization resolution of 30, the current battery capacity can be one of the values of the set

$${S}^{B} = \{ \frac{0}{30} {\overline{θ}}_{bc} , \frac{1}{30} {\overline{θ}}_{bc} , … , \frac{30}{30} {\overline{θ}}_{bc} \} .$$

Other factors can be considered/included in the state space. For example, one or more parameters of the navigation map can be included/considered in the state space. For example, the rate of battery discharge (i.e., a current rate of discharge), the degree of traffic (e.g., a congestion level), and/or other factors can be part of the state space S. In an example, the degree of traffic may be an ordinal variable having values such as (“light”, “average”, “heavy”). For example, factors related to the rate of battery discharge and/or the current power usage, such as whether an entertainment system, e.g., a radio, of the vehicle is on/off and/or whether the air conditioner/heater of the vehicle is on/off, can be considered in the state space. Furthermore, the scheduling of the eco mode activation can be based on the current power usage of the vehicle.

The action space A is the set of activation actions of the eco mode. The MOMDP selects one of the activation actions (e.g., whether to turn the eco mode on or off) for a next edge of the navigation map to be traversed immediately following the current edge. Thus, in an example, the action space A={off, on}. If the eco mode is currently in a state s_{M}∈S^{M}. and the next activation action sets the eco mode to the same state, then no action may be performed on the electric motor. That is, the current state does not change.

In some implementations, the action space A can include other actions related to other power-consuming components of the vehicle. For example, an action selected by the planner may be to lower the air conditioner of the vehicle to reduce the amount of battery power consumption.

The transition function T can include capturing the movement in (e.g., according to, etc.) the edges of the navigation map, the change in battery level, and the change in eco mode based on the navigation map and the activation action performed.

With respect to the costs C, several cost factors/functions can be considered. At least a subset of the following costs can be considered: total energy (kWh), wasted energy (kWh), battery regenerated (kWh), battery consumed (kWh), eco mode toggled, and time to traverse the edge (e.g., the expected time it takes to drive on the edge). Other costs are also possible. While the objective of the model (in this example the MOMDP) is to minimize the expected costs over time, the cost functions are the costs associated with a next immediate one-step cost of a next activation action.

A primary cost can be energy expenditure (in kWh). The energy expenditure can factor in the battery consumption or regeneration of traversing an edge in the navigation map, and the expected energy gains of regenerative braking. In addition to energy expenditure, the wasted energy (in kWh) can be measured. The wasted energy can represent the energy that could have been regenerated beyond the capacity of the battery, such as can happen on a long downhill road or being stopped at a traffic light. The toggling of the eco mode from off to on or from on to off is also a cost, as toggling can be inefficient. At least some of these costs (e.g., all of these costs) can be factored into the objective function and minimized by the eco mode activation planner.

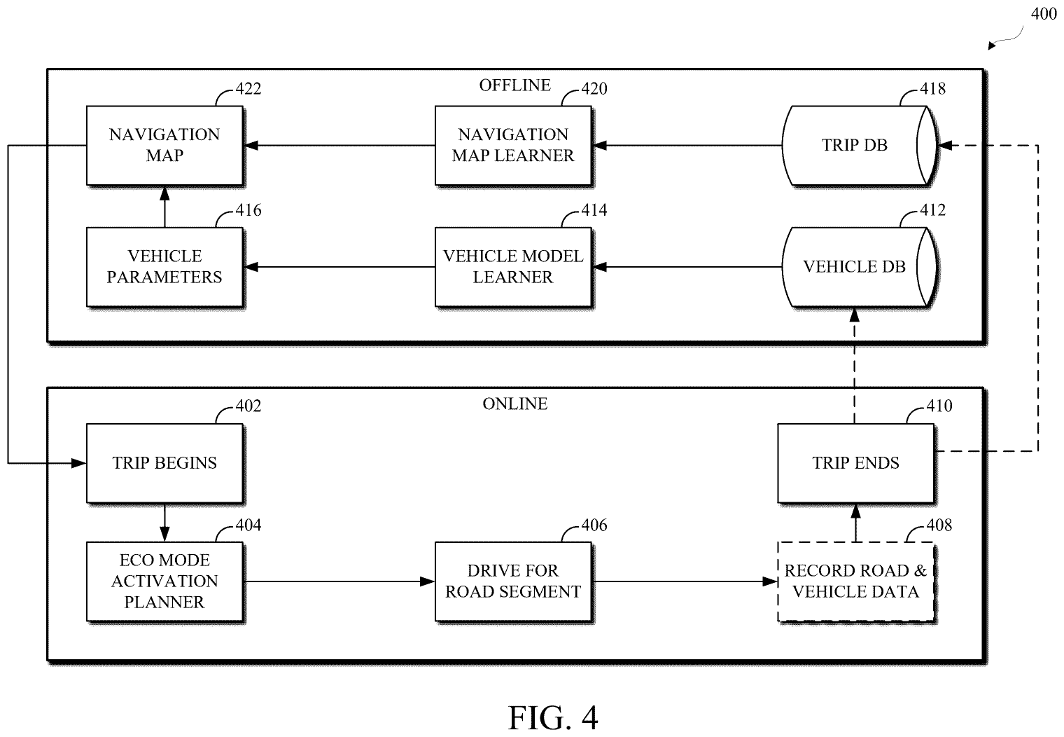

FIG. 4 illustrates a high-level flow 400 of eco mode activation planning according to implementations of this disclosure. A BEV may start a trip at 402. As mentioned above, the destination may or may not be known. An eco mode activation planner (i.e., planner) is initiated at 404 to select (e.g., plan, predict, etc.), for each next road segment, an eco mode activation action, based on a policy. The policy, an example of which is described above, may be determined (e.g., computed, calculated, etc.) online or offline.

In the online case, the policy is computed dynamically and can reflect/incorporate changes that are occurring in real or near real time as the vehicle traverses edges of a navigation map, which is described above. In another example, the policy may be calculated offline and used online (i.e., during actual drives of the BEV). An offline computed-policy may be computed once whereas an online-computed policy can be continually recomputed as the BEV is being driven. To compute the policy, as mentioned above, vehicle parameters and the navigation map are required. In the online case, the vehicle parameters and the navigation map may be static.

For an upcoming road segment, the planner determines an activation action (e.g., whether the engine should be on or off) on that segment of the road. The planner, which may be executing in the BEV, determines the activation action as described above with respect to the MOMDP. The planner can start to perform its algorithm as soon as the BEV is turned on. The BEV considers the possibilities (e.g., probabilities) of where the BEV (e.g., the driver of the BEV) may be going in the case that a route is not already known.

At 406, after the vehicle drives for a road segment of a predetermined length, the planner may optionally record, at 408, data related to at least some vehicle parameters, such as those described above with respect to FIG. 3. The data related to the vehicle parameters may be changed (e.g., updated, replaced, added to) by the new data. For example, the planner may record changes in the Battery Capacity. The planner may also record road data related to the segment (e.g., one or more edges) of the road that the BEV is currently traversing. The road data related to the segment can be or can include at least some of the parameters described with respect to Table II.

If the trip ends, then the flow 400 proceeds to 410; otherwise, the flow 400 returns to 404 to plan the next activation action. In an example, the flow 400 ends at 410. In another example, the recorded data at 410 (if any) may be transferred, such as to a central location (e.g., a cloud-based server). At the central location, the recorded vehicle parameters can be incorporated into a vehicle database 412 and the road data can be incorporated into a trip database 418. The respective data in the vehicle database 412 and the trip database 418 can be aggregated (e.g., averaged, statistically analyzed, etc.) by a vehicle model learner 414 and a navigation map learner 420, respectively. To illustrate, and without limitation, the navigation map learner 420 may determine, for a same road segment that is traversed multiple times, the Average Battery Consumption/Regeneration e_{cbcr} on that segment. In another example, the navigation map learner 420 may determine points (vertices) at which edges of the navigation map should be inserted, which may correspond, for example, to locations where the BEV stopped, such as at a traffic light or a stop sign. The vehicle model learner may update the Battery Capacity, and so on.

The navigation map learner 420 updates the navigation map 422, which can be or can include parameters such as those described with respect to Table I and Table II. The vehicle model learner 414 updates the vehicle parameters 416. The updated navigation map 422 and/or the updated vehicle parameters 416, or portions thereof, can then be provided to the BEV so that the updated information can be used in a next trip. The particular time the BEV receives the updates is not critical—the BEV can receive the updates before the next trip, at the start of the next trip, periodically, etc.

The navigation map 422 may include (e.g., incorporate) information received from many vehicles and many other trips on many other roads than those received from one vehicle trip and/or the updated vehicle parameters 416.

In an example, the vehicle model learner 414 and/or the navigation map learner 420 can be available (e.g., can execute in, etc.) the vehicle itself. In such a case, vehicle model learner 414 and/or the navigation map learner 420 only learn the patterns of one or more of the drivers of the BEV itself.

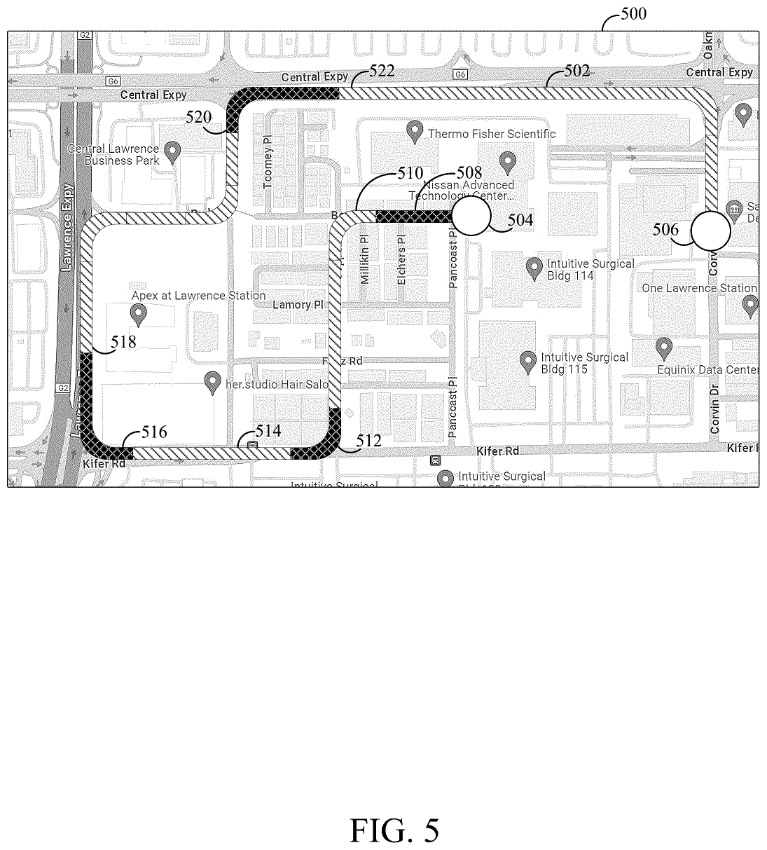

FIG. 5 illustrates an example 500 of a navigation map according to implementations of this disclosure. The navigation map can be the same as the navigation map 422 as described above in reference to FIG. 4. More specifically, the example 500 illustrates recorded data corresponding to eco mode activation during a driving session. The eco mode activation may be represented as edge parameters as described above in relation to Table II of FIG. 4. However, as mentioned above, edge parameters can include more, fewer, or other parameters. The recorded data can be captured by an eco mode activation planner, which can be the eco mode activation planner 404 of FIG. 4, which may be executing in or externally for a vehicle.

The example 500 shows recorded data for a driving session 502 with a start point 504 and a destination point 506. The driving session begins at the start point 504 and the eco mode activation planner records for edges corresponding to section 508 that the eco mode is deactivated. The eco mode activation planner records for the edges corresponding to section 510 that the eco mode is activate. The eco mode may be activated or deactivated by a driver of the vehicle, a pilot of the vehicle, or automatically by the eco mode activation planner, during the driving session 502. For each successive deactivation of the eco mode (i.e., section 512, section 516, and section 520) the eco mode activation planner records the eco mode as deactivated for the corresponding edges. On the other hand, for each successive activation of the eco mode (i.e., section 514, section 518, and section 522), the eco mode activation planner records the eco mode as activated for the corresponding edges.

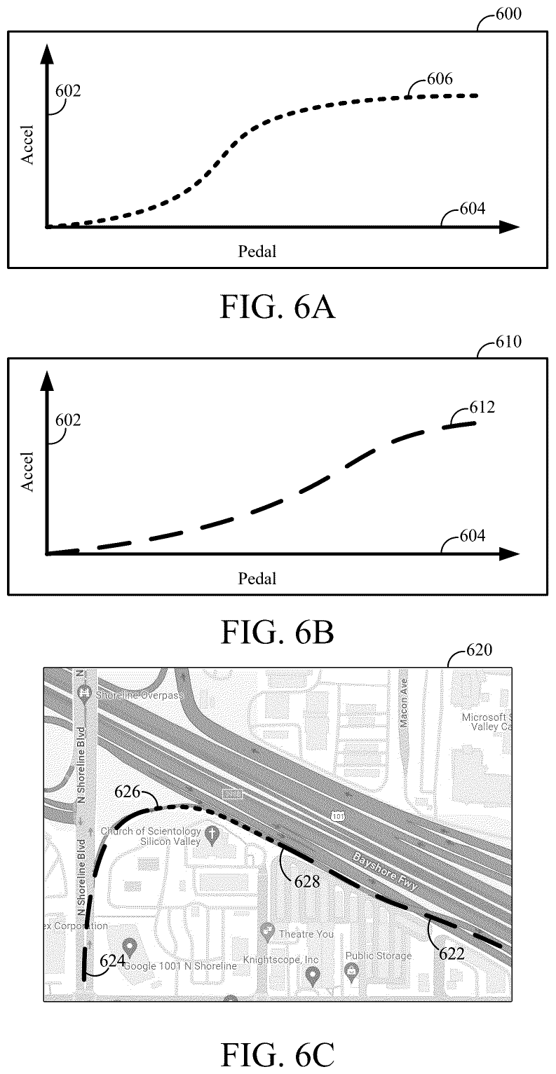

FIGS. 6A-6C illustrate examples of operations of an eco mode according to implementations of this disclosure. The graph 600 in FIG. 6A depicts the relationship between an accelerator pedal input and the resulting rate of acceleration in a vehicle operating when the eco mode is not active. The y-axis 602 indicates the rate of acceleration, which corresponds to how quickly the speed of the vehicle is increasing. The x-axis 604 denotes an amount (e.g., an angle, a distance, etc.) the accelerator pedal is pressed. The line graph 606 illustrates that when the eco mode is not active, the rate of acceleration increases rapidly at first with respect to how far the accelerator pedal is pressed. This means that even a small press on the accelerator pedal will result in a noticeable increase in the acceleration of the vehicle.

Operating the vehicle with the eco mode not active offers distinct advantages in situations requiring increased responsiveness or power. For instance, during highway merging (where quicker acceleration is necessary to match traffic flow) or when overtaking slower vehicles, the eco mode not being active allows the driver to achieve the desired acceleration with a smaller accelerator pedal press. This can improve maneuverability and provide a more assured driving experience in situations demanding a relatively quick response.

The graph 610 in FIG. 6B depicts the relationship between an accelerator pedal input and the resulting rate of acceleration in a vehicle operating when the eco mode is active. The y-axis 602 indicates the rate of acceleration, which corresponds to how quickly the speed of the vehicle is increasing. The x-axis 604 denotes an amount the accelerator pedal is pressed. The line graph 612 illustrates that when the eco mode is active, the rate of acceleration increases slowly with respect to how far the accelerator pedal is pressed. This means that even pressing the accelerator pedal down significantly will result in a gradual increase in the acceleration of the vehicle.

A slower acceleration curve resulting from eco mode can offer several benefits. First, eco mode directly contributes to an extended range in BEVs. This is because gradual acceleration prevents sudden bursts of energy consumption, which drain battery power more quickly. Additionally, eco mode fosters a smoother driving experience, especially in stop-and-go traffic where aggressive acceleration can be uncomfortable. Reducing harsh acceleration patterns can also lower wear and tear on the components of the vehicle. Lastly, some drivers might find the more gradual acceleration response of eco mode to be a safety enhancement, minimizing the potential for sudden unintended speed increases.

Finding an optimal balance between eco mode activation and deactivation is important for a BEV to achieve a balance between efficiency and driving dynamics. While eco mode typically promotes a smoother driving experience by limiting acceleration, there are situations where deactivating it can be advantageous. Merging onto a busy highway or overtaking another vehicle might require quicker acceleration. Similarly, navigating hilly terrain may necessitate more power than eco mode allows for comfortable or safe driving. Therefore, a system that intelligently adjusts eco mode based on real-time driving conditions and driver needs can offer the best of both worlds—maximizing battery range during regular driving while enabling more responsive performance when the situation demands it.

FIG. 6C depicts a scenario 620 where a BEV utilizes eco mode intelligently to balance efficiency and driving performance along a route 622. As the BEV approaches a freeway on-ramp at location 624, the eco mode is active. At location 626, the eco mode is deactivated, granting the operator immediate access to increased acceleration for merging onto the freeway. Once the vehicle has successfully merged and presumably reached freeway speeds, the eco mode is reactivated at location 628. This prioritizes efficient energy consumption during highway cruising. This approach exemplifies how eco mode adjustments can optimize battery range based on driving conditions. The system automatically allocates more power for maneuvers requiring extra acceleration, like freeway merging, and then switches back to eco mode for steady-state (e.g., highway) driving.

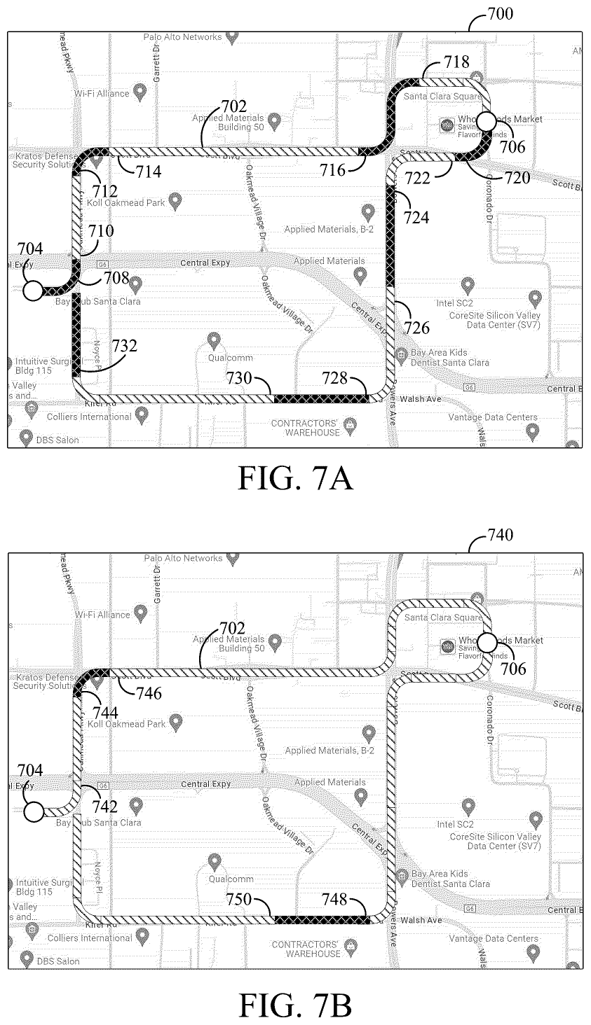

FIGS. 7A and 7B illustrate examples of an eco mode activation plan according to implementations of this disclosure. FIG. 7A is an example 700 of an eco mode activation plan when a BEV has a high battery level. A high battery level is, in some implementations, a charge greater than or equal to 80%, or some other level and/or measure. The example 700 depicts a navigation map showing a round trip route 702 from a start point 704 to an end point 706 then from the end point 706 back to the start point 704. The navigation map can be the same as or similar to the navigation map 422 as described above in reference to FIG. 4. Given the high battery level the eco mode activation planner, which may be the eco mode activation planner 404 of FIG. 4, executing in/for the vehicle may generate an eco mode activation plan that maximizes performance or minimizes travel time. This might translate to the eco mode remaining deactivated for longer segments of the trip. For example, the eco mode activation policy may result in the eco mode being deactivated during 50% of the trip from the start point 704 to the end point 706 and for 60% of the trip from the end point 706 to the start point 704.

The example 700 further depicts the specific segments of the route in which the eco mode is activated or deactivated. Specifically, the eco mode is deactivated for segment 708, segment 712, and segment 716 as the vehicle traverses the route 702 from the start point 704 to the end point 706. During the return trip from the end point 706 to the start point 704 the eco mode is deactivated for segment 720, segment 724, segment 728, and segment 732. Additionally, the eco mode is active for segment 710, segment 714, and segment 718 along the route 702 from the start point 704 to the end point 706. During the return trip from the end point 706 to the start point 704 the eco mode is active for segment 722, segment 726, and segment 730. This eco mode activation plan demonstrates how the eco mode activation planner intelligently balances range extension with a responsive driving experience when battery capacity allows.

FIG. 7B is an example 740 of an eco mode activation plan when a BEV has a low battery level. A low battery level may be indicated by a charge of less than or equal to 20%, or some other value and/or measure. The example 700 depicts a navigation map showing a round trip route 702 from a start point 704 to an end point 706 then from the end point 706 back to the start point 704. The navigation map can be the same as or similar to the navigation map 422 as described above in reference to FIG. 4. Given the level battery level the eco mode activation planner, executing in/for the vehicle, may generate an eco mode activation plan that maximizes battery life or minimizes total energy consumption. For example, the eco mode activation policy may result in the eco mode being activated during 90% of the trip from the start point 704 to the end point 706 and for 80% of the trip from the end point 706 to the start point 704.

The example 740 further depicts the specific segments of the route in which the eco mode is activated or deactivated. Specifically, the eco mode is activated for segment 742 and segment 746 as the vehicle traverses the route 702 from the start point 704 to the end point 706. During the return trip from the end point 706 to the start point 704 the eco mode is activated for segment 746 and segment 750. Additionally, the eco mode is deactivated for segment 744 along the route 702 from the start point 704 to the end point 706. During the return trip from the end point 706 to the start point 704 the eco mode is deactivated for segment 748. This eco mode activation plan demonstrates how the eco mode activation planner intelligently balances range extension with a responsive driving experience when battery capacity is low.

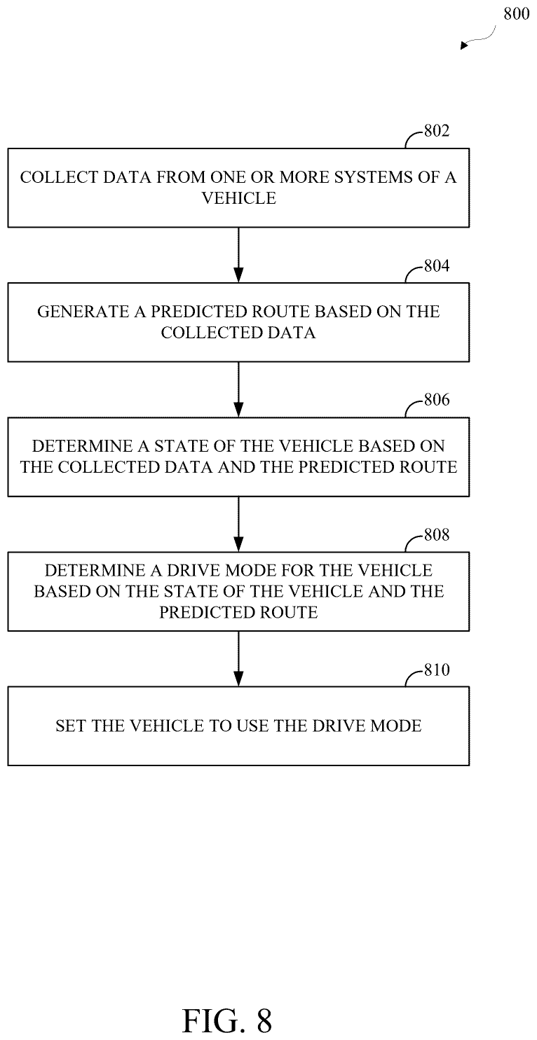

FIG. 8 a flowchart diagram of an example of a technique 800 for eco mode activation in accordance with an embodiment of this disclosure. The technique 800 can be implemented, partially or fully, by a BEV, such as a battery electric vehicle as described with respect to FIG. 3. The technique 800 can be implemented in an autonomous vehicle (AV) BEV, which can be the vehicle 100 shown in FIG. 1, one of the vehicles 210/211 shown in FIG. 2, a semi-autonomous vehicle, or any other vehicle that may include drive-assist capabilities, including remote control of the vehicle. The technique 800 can be implemented as instructions that are stored in a memory, such as the memory 134 of FIG. 1. The instructions can be executed by a processor, such as the processor 133 of FIG. 1. The technique 800 may be performed in whole or in part by hardware.

At operation 802, data is collected from one or more systems of a vehicle. The collected data could include navigation information (with potentially aggregated driver data for traffic predictions), a current state-of-charge of the battery, and a current discharge rate (i.e., current rate of discharge) of the battery. The data may be collected by the eco mode activation planner, such as the eco mode activation planner 404 of FIG. 4. The vehicle systems may include but are not limited to a navigation system, a communication system, or a system that monitors operator or driver behavior. In some implementations, the eco mode activation planner may collect data about external factors such as traffic patterns (i.e., traffic data), proximity to other vehicles (i.e., proximity data), and weather data (i.e., weather conditions). For example, consider a BEV preparing for a morning commute in a suburban area. The eco mode activation planner begins by collecting relevant data. A navigation system provides a planned route and may incorporate aggregated driver/operator data to predict traffic congestion along the way. Simultaneously, the eco mode activation planner queries the battery management system of the BEV for the current state-of-charge (e.g., 75%) and the current discharge rate (i.e., current rate of discharge). Optionally, an external communication system (e.g., smartphone of a driver) might provide weather data (e.g., clear skies expected) and real-time updates on traffic flow. Additionally, a driver behavior monitoring system may offer insights into the acceleration preferences of the driver (e.g., a preference for moderate acceleration).

At operation 804, a predicted route is generated (e.g., calculated, determined, etc.) based on the collected data. The predicted route may include turn-by-turn navigation combined with aggregated driver data or real-time traffic information to refine the prediction based on likely speeds and potential delays along specific segments of the route. The predicted route may be generated by the eco mode activation planner or may be generated externally of the eco mode activation planner and transmitted to the eco mode activation planner. The eco mode activation planner may analyze the driver behavior data to predict if the driver is likely to deviate from the suggested route, perhaps based on past commutes or preferred alternative routes known by the eco mode activation planner.

At operation 806, a state of the vehicle is determined (e.g., calculated, inferred, etc.) based on the collected data and the predicted route. That is, the eco mode activation planner uses the predicted route and the collected data to make a determination of the current state of the vehicle. While the state-of-charge of the battery and the current discharge rate of the battery are primary factors, other factors may be considered. The eco mode activation planner could factor in elevation differences (e.g., uphills increasing discharge, downhills enabling regeneration), predicted energy expenditure in traffic, and the impact of the driver's acceleration preferences on battery usage. Additionally, other vehicle systems could be queried for factors such as current tire pressure (affecting rolling resistance), heating, ventilation, and air conditioning (HVAC) settings, or any potential limitations imposed by warning lights or other system alerts. This allows for a holistic state determination.

At operation 808, a drive mode is determined (e.g., calculated, etc.) for the vehicle based on the state of the vehicle and the predicted route. In other words, the eco mode activation planner may leverage the previously determined vehicle state and the predicted route to select an optimal drive mode. This is where the decision-making model (i.e., the model, such as the MOMDP, described above) analyzes various trade-offs and may utilize one or more scalarization functions to prioritize different aspects of the journey. For example, the algorithm could prioritize minimizing overall energy consumption, minimizing battery drain, maximizing regenerative braking potential, reducing abrupt changes in drive modes to improve driver experience, minimizing overall trip time, other aspects, or some combination thereof. The decision-making model weighs these goals against the projected route and the current state of the vehicle. This ensures the determined drive mode is tailored for the predicted route and the current state of the vehicle.

At operation 810, the vehicle is set to use the drive mode. That is, the eco mode activation planner translates the determined drive mode into an activation action by generating an eco mode activation plan. The eco mode activation plan may be utilized by a control module of the vehicle such as the control module 324 of FIG. 3. The control module utilizes the plan to automatically (i.e., without driver intervention) set the drive mode (i.e., activate or deactivate the eco mode) of the vehicle according to the plan. For example, the decision-making model may determine that to maximize range, eco mode should be active for 60% of the predicted route. At 810, the control module engages eco mode, limiting the available power output and modifying acceleration curves.

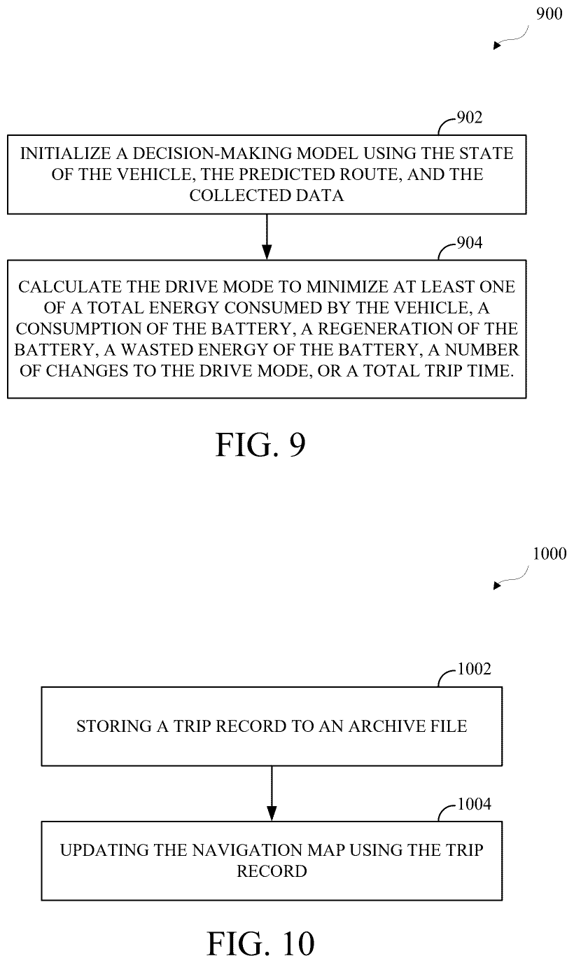

FIG. 9 is a flowchart diagram of an example of a technique 900 for calculating the drive mode of a vehicle in accordance with an embodiment of this disclosure. The technique 900 can be implemented, partially or fully, by a BEV, such as a battery energy vehicle as described with respect to FIG. 3. The technique 900 can be implemented in an AV that is a battery electric vehicle, which can be the vehicle 100 shown in FIG. 1, one of the vehicles 210/211 shown in FIG. 2, a semi-autonomous vehicle, or any other vehicle that may include drive-assist capabilities. The technique 900 can be implemented as instructions that are stored in a memory, such as the memory 134 of FIG. 1. The instructions can be executed by a processor, such as the processor 133 of FIG. 1. The technique 900 may be performed in whole or in part using hardware.

At operation 902, a decision-making model (i.e., the model, such as the MOMDP, described above) is initialized (e.g., instantiated, prepares, etc.) using the state of the vehicle, the predicted route, and the collected data. In other words, the eco mode activation planner prepares the decision-making model for determining the drive mode strategy (e.g., the eco mode activation plan). Initialization of the decision-making model (in this example an MOMDP) involves providing the decision-making model with all the relevant information. The information includes the state of the vehicle, the predicted route, and the collected data relevant for the calculation. Additionally, the initialization process may involve preprocessing the data into a format the decision-making model can understand or extracting specific features from the raw data that the decision-making model is capable of working with.

For example, the decision-making model may use elevation changes along the route to optimize eco mode activations. During the initialization, the predicted route data from the navigation system may be processed to identify uphill and downhill segments. The decision-making model can also calculate the percentage grade of these inclines and/or declines. This preprocessed elevation data, along with the battery's state-of-charge, may represent a portion of the input used to initialize the decision process.

At operation 904, the drive mode is calculated (e.g., determined, generated, etc.) to minimize at least one of a total energy consumed by the vehicle, a consumption of the battery, a regeneration of the battery, a wasted energy of the battery, a number of changes to the drive mode, or a total trip time. That is, the decision-making model is guided by one or more objectives. An objective may be set based on the preferences of a driver or preconfigured within the eco mode activation planner. These objectives might include minimizing total energy consumption, minimizing battery consumption, maximizing regeneration potential, reducing wasted energy, minimizing frequent drive mode changes, prioritizing trip time, or some combination thereof.

Each objective influences the calculations of decision-making model differently. For example, if minimizing total energy consumption is the top priority, the decision-making model may create a plan where eco mode stays active for most of the route. The decision-making model can strategically identify short segments where a slight loss in efficiency is acceptable (e.g., short uphill sections) to maintain eco mode usage for longer stretches in the overall trip.

FIG. 10 is a flowchart diagram of an example of a technique 1000 for storing a trip record according to an implementation of this disclosure. The technique 1000 can be implemented, partially or fully, by a BEV, such as a battery energy vehicle as described with respect to FIG. 3. The technique 1000 can be implemented in an AV that is a battery electric vehicle, which can be the vehicle 100 shown in FIG. 1, one of the vehicles 210/211 shown in FIG. 2, a semi-autonomous vehicle, or any other vehicle that may include drive-assist capabilities, including those that can be remotely controlled. The technique 1000 can be implemented as instructions that are stored in a memory, such as the memory 134 of FIG. 1. The instructions can be executed by a processor, such as the processor 133 of FIG. 1. The technique 1000 can be operated in whole or in part using hardware.

At operation 1002, a trip record is stored to an archive file. That is the eco mode activation planner may create a record road and vehicle data, such as the road and vehicle data recorded at 408 of FIG. 4. The trip record may include various types of data including but not limited to changes in battery state-of-charge, electric motor temperature, and road segment data. Additionally, the trip record may include the predicted route used to generate the eco mode activation plan, along with the actual route the vehicle followed. Further, the trip record may include the activation state of the eco mode throughout the trip, associated with specific timestamps and road segments.

At operation 1004, the navigation map is updated using the trip record. That is the eco mode activation planner refines the navigation map using the detailed information contained within the trip record. The navigation map may be the same as or similar to the navigation map 422 of FIG. 4. The refinement of the navigation map may be performed by the navigation map learner 420. The navigation map learner 420 may extract valuable insights from the trip record, leading to several types of updates. For example, if the trip record consistently shows heavier traffic than initially predicted on a specific road segment, the navigation map learner 420 might increase the energy consumption value associated with that segment. Knowing this, the eco mode activation planner can proactively activate eco mode earlier in future trips to compensate. Similarly, if the driver repeatedly deviates from the predicted routes, the navigation map learner 420 might modify the navigation map to include these preferred alternatives, which may help tailor a future eco mode plan accordingly.

Additionally, the navigation map learner 420 can identify areas with significant regenerative braking potential. By analyzing steep downhill segments where the trip record indicates substantial battery recharge, future routes can be planned to prioritize these regenerative opportunities. This can further improve overall energy efficiency.

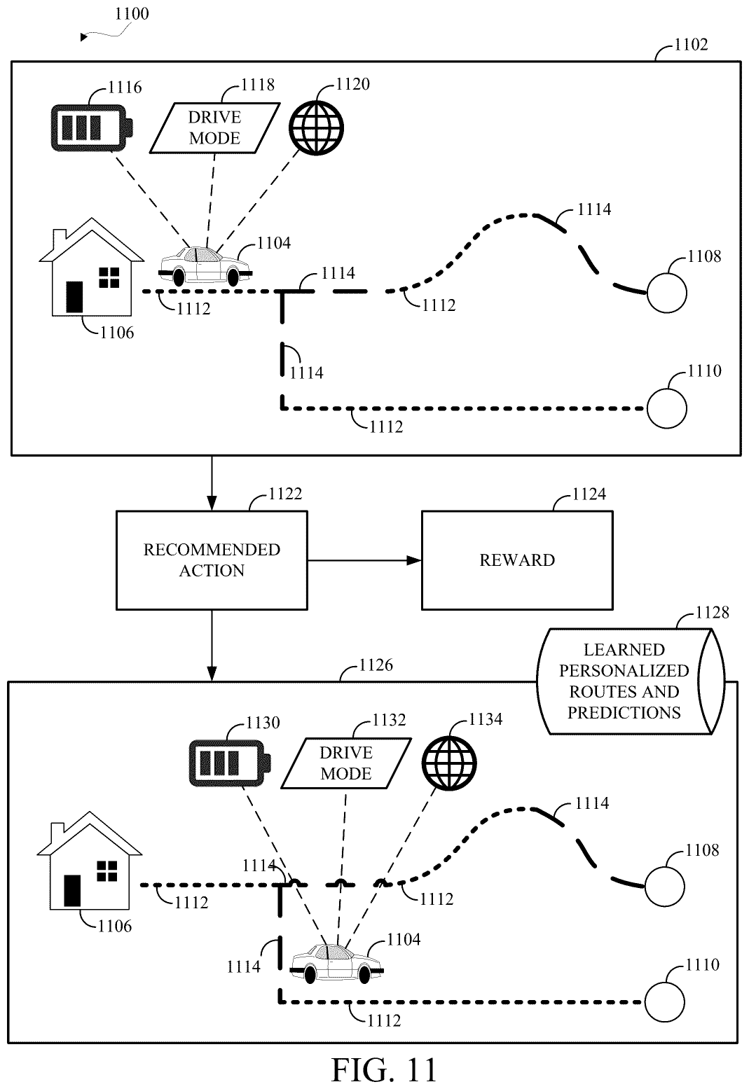

FIG. 11 visually illustrates an example of a state space according to implementations of this disclosure. While certain metadata and respective (possible) values are described with respect to the example 1100, in other examples, more, fewer, other parameters and respective possible values, or a combination thereof, can be available.

As described in detail above, the state space can be defined as S=S^{T}×S^{B}×S^{M} where S^{T} can be the set of edges of a navigation map (such as the navigation map 422 of FIG. 4) and corresponding metadata. The navigation map can be a fixed map, a learned navigation map, or a combination thereof (e.g., an initially fixed map that can be improved by learning while the vehicle is traversing a vehicle transportation network).

A scene 1102 illustrates a first state of a vehicle 1104 as may be determined by an eco mode activation planner, such as the eco mode activation planner 404 of FIG. 4. The first state may represent the vehicle 1104 at the beginning of a driving session. The driving session may begin at a residence 1106. Based on the information available to the eco mode activation planner at the first state, the eco mode activation planner may predict multiple possible destinations, here destination 1108 and destination 1110. Furthermore, the eco mode activation planner can use information provided from various systems of the vehicle 1104 to help generate an eco mode activation plan. The various systems of the vehicle may be the systems as described above at 802 of FIG. 8. The data received from the various systems of the vehicle 1104 may be the same as or similar to the data collected with reference to 802 of FIG. 8 above. The data collected in the scene 1102 may include but is not limited to a current state of charge of the battery 1116, a current drive mode 1118 of the vehicle, and the current location 1120 of the vehicle 1104.

The eco mode activation planner may also generate possible routes that the vehicle 1104 may traverse. For each possible route the eco mode activation planner may generate an eco mode activation plan detailing areas of the route in which the eco mode is desirably active, such as segment 1112, and areas of the route in which the eco mode is desirably deactivated, such as segment 1114. Additionally, the eco mode activation planner may assign a probability that the vehicle 1104 will traverse each of the predicted routes. This information is then used to generate a recommended action 1122. The recommended action 1122 is used to generate the eco mode activation plan based on the recommended action for the current road segment. The recommended action 1122 is an activation action as described above in relation to FIG. 3, which is used to determine whether the eco mode of the vehicle 1104 is turned on or off for a current road segment.

In addition to the recommended action 1122, the eco mode activation planner generates a reward 1124 associated with the recommended action 1122. The reward 1124 is used by a decision-making model (in this example an MOMDP) to align the decision-making model with the desired objectives. The reward value might reflect the predicted reduction in energy consumption, the increase in battery range, or the potential for enhanced regenerative braking associated with the recommended action. It could also factor in elements like driver comfort or deviations from preferred driving styles if such optimizations are desired. By assigning rewards, the eco mode activation planner reinforces positive outcomes and guides the decision-making model towards selections that support the primary efficiency and range maximization goals.

A scene 1126 illustrates a second state of a vehicle 1104 as may be determined by the eco mode activation planner. The second state may represent the vehicle 1104 at the next segment of the route during the driving session. The eco mode activation planner may update the eco mode activation plan based on the second state of the vehicle 1104. The eco mode activation planner may eliminate one or more predicted routes based on the route the vehicle 1104 has traversed thus far. For example, as depicted by the scene 1126, the eco mode activation planner may eliminate destination 1108 as a possible destination thus leaving destination 1110 as the only predicted route. Alternatively, the eco mode activation planner may predict new destinations (not shown) based on the route traversed thus far. Furthermore, the eco mode activation planner may obtain updated information from various systems of the vehicle 1104 to help generate the eco mode activation plan for the next road segment. The updated vehicle information may include but is not limited to an updated state of charge of the battery 1130, an updated drive mode 1132 of the vehicle 1104, and a new location 1134 of the vehicle 1104.

In addition to the updated state information of the vehicle, the eco mode activation planner may utilize learned personalized routes and predictions 1128. The learned personalized routes and predictions 1128 may be derived (e.g., determined, extrapolated, inferred, generated, etc.) from the road and vehicle data record in relation to 408 of FIG. 4. The learned personalized routes and predictions 1128 may be stored in the trip database 418, the vehicle database 412, or any combination thereof. The eco mode activation planner leverages the learned personalized routes and predictions 1128 to tailor the eco mode activation plan to the specific driver and vehicle. The eco mode activation planner uses this additional information to refine a destination prediction, potentially eliminating unlikely routes and even suggesting new destinations based on the past patterns of the driver. Further, the eco mode activation planner can analyze the learned routes alongside the updated vehicle state (e.g. state of charge, drive mode, location) to make highly informed decisions. For instance, if a driver frequently takes a route with significant downhill segments, the planner might proactively prioritize regenerative braking opportunities in its eco mode activation plan. This evaluation (i.e., update and reevaluation) of the state information can continue for each segment of the route until the vehicle 1104 reaches the destination.

Intelligent eco mode optimization, as described above, provides several benefits for BEVs. By planning eco mode activation based on route prediction, real-time vehicle data, learned driver preferences, or any combination thereof, overall energy efficiency is significantly improved. This directly translates to extended range, which is a concern for BEV operators. Additionally, intelligent eco mode optimization can maximize utilization of regenerative braking opportunities, further increasing energy conservation. Moreover, the ability to learn and adapt to individual driving styles delivers a more personalized experience which can lead to further energy conservation and efficiencies over time. Adapting the intelligent eco mode optimization to individual driving styles provides a significant benefit for BEV drivers by accounting for driver preferences and tailoring the eco mode activation accordingly. Drivers who prioritize efficiency can enjoy extended range, while those who occasionally favor a more responsive driving experience can still access the full acceleration capabilities of the vehicle when needed. This personalized approach strikes a balance between efficiency and driver preferences, offering flexibility without compromising comfort or safety. Furthermore, even with eco mode active, the eco mode can be suspended temporarily in scenarios where immediate acceleration is necessitated, such as merging or navigating fast-moving traffic. This ensures drivers maintain a sense of control and confidence in all driving situations.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the terminology “example”, “embodiment”, “implementation”, “aspect”, “feature”, or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify”, or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or” unless specified otherwise, or clear from context. In addition, the articles “a” and “an” as used in this application and the appended claims should generally be construed to mean “one or more” unless specified otherwise or clear from context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

The above-described aspects, examples, and implementations have been described in order to allow easy understanding of the disclosure are not limiting. On the contrary, the disclosure covers various modifications and equivalent arrangements included within the scope of the appended claims, which scope is to be accorded the broadest interpretation so as to encompass all such modifications and equivalent structure as is permitted under the law.

What is claimed is:

1. A method, comprising:
collecting data from one or more systems of a vehicle, wherein the vehicle comprises a battery;
generating a predicted route based on the collected data, wherein the collected data includes a navigation map for a portion of a vehicle transportation network;
determining a state of the vehicle based on the collected data and the predicted route;
determining, using a decision-making model, a drive mode for the vehicle based on the state of the vehicle and the predicted route, wherein the drive mode one of a first drive mode having a first acceleration curve responsive to an operator request for acceleration or a second drive mode have a second acceleration curve responsive to the operator request for acceleration, wherein the second drive mode reduces a rate of discharge of the battery as compared to the first drive mode; and
setting the vehicle to use the drive mode.

2. The method of claim 1, wherein the state of the vehicle comprises at least one of a current charge of the battery, or a current rate of discharge of the battery.

3. The method of claim 2, wherein determining the drive mode for the vehicle comprises:
initializing the decision-making model using the state of the vehicle, the predicted route, and the collected data; and
calculating, using the decision-making model, the drive mode to minimize at least one of a total energy consumed by the vehicle, a consumption of the battery, a regeneration of the battery, a wasted energy of the battery, a number of changes to the drive mode, or a total trip time.

4. The method of claim 3, wherein the decision-making model is a multi-objective Markov decision process (MOMDP).

5. The method of claim 1, wherein the one or more systems of the vehicle comprises at least one of a navigation system, a communication system, or a system that monitors a driver behavior.

6. The method of claim 1, comprising:
storing a trip record to an archive file, wherein the trip record comprises:
the collected data;
the predicted route;
an actual route of the vehicle;
the state of the vehicle and a first timestamp associated with the state of the vehicle; and
the drive mode and a second timestamp associated with the drive mode of the vehicle; and
updating the navigation map using the trip record.

7. The method of claim 1, wherein the navigation map includes aggregated driver data from an external source.

8. The method of claim 1, wherein the collected data comprises:
traffic data for the portion of the vehicle transportation network;
proximity data of a road user other than the vehicle;
weather conditions for a location of the vehicle; and
driver behavior data for a driver of the vehicle.

9. An apparatus, comprising:
a memory subsystem; and
one or more processors configured to execute instructions stored in the memory subsystem to:
collect data from one or more systems of a vehicle, wherein the vehicle comprises a battery;
generate a predicted route based on the collected data, wherein the collected data includes a navigation map for a portion of a vehicle transportation network;
determine a state of the vehicle based on the collected data and the predicted route;
determine, using a decision-making model, a drive mode for the vehicle based on the state of the vehicle and the predicted route, wherein the drive mode one of a first drive mode having a first acceleration curve responsive to an operator request for acceleration or a second drive mode have a second acceleration curve responsive to the operator request for acceleration, wherein the second drive mode reduces a rate of discharge of the battery as compared to the first drive mode; and
set the vehicle to use the drive mode.

10. The apparatus of claim 9, wherein the state of the vehicle comprises at least one of a current charge of the battery or a current rate of discharge of the battery.

11. The apparatus of claim 10, wherein the instructions to determine the drive mode for the vehicle includes to:
initialize the decision-making model using the state of the vehicle, the predicted route, and the collected data; and
calculate, using the decision-making model, the drive mode to minimize at least one of a total energy consumed by the vehicle, a consumption of the battery, a regeneration of the battery, a wasted energy of the battery, a number of changes to the drive mode, or a total trip time.

12. The apparatus of claim 9, wherein the one or more systems of the vehicle comprises at least one of a navigation system, a communication system, or a system that monitors a driver behavior.

13. The apparatus of claim 9, the instructions stored in the memory subsystem comprise instructions to:
store a trip record to an archive file, wherein the trip record comprises:
the collected data;
the predicted route;
an actual route of the vehicle;
the state of the vehicle and a first timestamp associated with the state of the vehicle; and
the drive mode and a second timestamp associated with the drive mode of the vehicle; and
update the navigation map using the trip record.

14. The apparatus of claim 9, wherein the navigation map includes aggregated driver data from an external source.

15. The apparatus of claim 9, wherein the collected data comprises:
traffic data for the portion of the vehicle transportation network;
proximity data of a road user other than the vehicle;
weather conditions for a location of the vehicle; and
driver behavior data for a driver of the vehicle.

16. A non-transitory computer-readable storage medium storing instructions operable to cause one or more processors to perform operations comprising:
collecting data from one or more systems of a vehicle, wherein the vehicle comprises a battery;
generating a predicted route based on the collected data, wherein the collected data includes a navigation map for a portion of a vehicle transportation network;
determining a state of the vehicle based on the collected data and the predicted route;
determining, using a decision-making model, a drive mode for the vehicle based on the state of the vehicle and the predicted route, wherein the drive mode one of a first drive mode having a first acceleration curve responsive to an operator request for acceleration or a second drive mode have a second acceleration curve responsive to the operator request for acceleration, wherein the second drive mode reduces a rate of discharge of the battery as compared to the first drive mode; and
setting the vehicle to use the drive mode.

17. The non-transitory computer-readable storage medium of claim 16, wherein the state of the vehicle comprises at least one of a current charge of the battery or a current rate of discharge of the battery.

18. The non-transitory computer-readable storage medium of claim 17, wherein determining the drive mode for the vehicle comprises:
initializing the decision-making model using the state of the vehicle, the predicted route, and the collected data, wherein the decision-making model is a multi-objective Markov decision process (MOMDP); and
calculating, using the decision-making model, the drive mode to minimize at least one of a total energy consumed by the vehicle, a consumption of the battery, a regeneration of the battery, a wasted energy of the battery, a number of changes to the drive mode, or a total trip time.

19. The non-transitory computer-readable storage medium of claim 16, wherein the one or more systems of the vehicle comprises at least one of a navigation system, a communication system, or a system that monitors a driver behavior.

20. The non-transitory computer-readable storage medium of claim 16, the operations further comprising:
storing a trip record to an archive file, wherein the trip record comprises:
the collected data;
the predicted route;
an actual route of the vehicle;
the state of the vehicle and a first timestamp associated with the state of the vehicle; and
the drive mode and a second timestamp associated with the drive mode of the vehicle; and
updating the navigation map using the trip record.
